(19) United States
(12) Patent Application Publication
(10) Pub. No.: US 2019/0346054 A1
(43) Pub. Date: Nov. 14, 2019

(54) BALL CHECK VALVE

(71) Applicant: David John Miko, Oveido, FL (US)

(72) Inventor: David John Miko, Oveido, FL (US)

(21) Appl. No.: 16/381,377

(22) Filed: Apr. 11, 2019

Related U.S. Application Data
(60) Provisional application No. 62/669,197, filed on May 9, 2018.

(51) Int. Cl. F16K 15/04; F16K 27/02

(52) U.S. Cl. CPC F16K 15/04; A01G 25/16; F16K 27/0209

(57) ABSTRACT

A ball check valve for individual sprinkler heads of an irrigation system is provided. The ball check valve stops the water flow of unregulated flow resulting from a malfunctioning sprinkler head/nozzle incapable of sufficiently decreasing, regulating the water flow. The ball check valve provides a sealing ring fluidly communicating an upper and lower flow bores within a valve tube, wherein the sealing ring provides a downward-facing arcuate surface dimensioned to snugly receive a ball bearing in a closed position when urged so. The ball check valve is adapted so that only unregulated flow urges the closed position, wherein a regulated flow from a properly functioning sprinkler head enables an open position with the ball bearing below the sealing ring in the lower flow bore.

### CROSS-REFERENCE TO RELATED APPLICATION

This application claims the benefit of priority of U.S. provisional application No. 62/669,197, filed 9 May 2018, the contents of which are herein incorporated by reference.

### BACKGROUND OF THE INVENTION

The present invention relates to check valves and, more particularly, to a ball check valve for an irrigation system, wherein the ball check valve provides a ball bearing for stopping water loss when an operatively associated nozzle malfunctions or is broken.

Fixed or pop up spray heads of an irrigation system, when broken, let excess water flow out of the pipes at three times the operating rate. Most irrigation systems have no discrete, in situ shut off solution individual spray nozzle failures.

Rather, current irrigation systems have different approaches in solving the problem of individual sprinkler head malfunction, all with their own disadvantages. Some have selective shutoffs for the entire system but not individual heads, thereby allowing the rogue sprinkler head result in the severe overwatering and thus damage to their section of lawn. Other designs employ automatically shut off the entire system if an individual problem is detected, which adversely effects an area of grass/lawn much larger than the area associated with the lone damaged sprinkler head. Another design has the shutoff in the nozzle body of individual sprinkler head, but if that portion of the body is damaged or lost such shutoff mechanism fails to work. Similarly, nozzle-shutoff designs will not work if the nozzle is broken off or the shaft it is attached to is broken or if the entire assembly pops out of the case, all three of these being the most likely causes of individual sprinkler head failure.

As can be seen, there is a need for a ball check valve embodied in each individual sprinkler system head/nozzle so when the water flow is not be regulated to a flow rate less than the operable, predetermined flow rate, the water flow through that individual sprinkler head is prevented. The check valve provides a ball in a flow bore for stopping water loss when an operatively associated nozzle malfunctions or is broken, thereby eliminating the need for an entire system shutdown. Additionally, the ball check valve is not adversely affected if the nozzle, shaft or any internal workings of the pop-up spray nozzle fails, and as a result, if only one sprinkler head is broken only a very small section of grass/lawn is affected.

The ball inside the flow bore is adapted to automatically stop the excess water flow to the nozzle opening when the volume of water increases due to a nozzle malfunction, since the ball is pushed up into the top of the flow bore and nested into a sealing ring, restricting excess water loss in such situations. And the ball will continue to do so until the nozzle is replaced. The present invention can easily replace any older nozzle body without a need for any modifications to the entire irrigation system.

### SUMMARY OF THE INVENTION

In one aspect of the present invention, ball check valve for an individual sprinkler head of an irrigation system includes the following: a valve tube having fluidly connected upper and lower flow bores; a sealing ring separating said upper and lower flow bores; the sealing ring providing a ring flow bore fluidly coupling the upper and lower flow bores; a downward-facing arcuate surface provided along a lower portion of the sealing ring, wherein the lower portion protrudes in the lower flow bore; and a ball disposed in the lower flow bore, wherein the ball is dimensioned to abut the arcuate surface so as to fluidly block the ring flow bore.

In another aspect of the present invention, ball check valve for an individual sprinkler head of an irrigation system includes the following: a valve tube having fluidly connected upper and lower flow bores; the valve tube extends between a bottom end and a top end, wherein the bottom end is dimensioned to operatively associate with a water supply, and wherein the top end is dimensioned to operatively associate with a sprinkler head; a sealing flange disposed between the upper and the lower flow bores; the sealing flange defining a sealing flow bore; a sealing ring having a base portion and a flange portion that both define a shared ring flow bore; and the base portion dimensioned to slide into and abut the sealing flow bore, wherein the flange portion provides a downward-facing arcuate surface provided along a lower portion of the sealing ring, wherein the lower portion protrudes in the lower flow bore; a ball disposed in the lower flow bore, wherein the ball is dimensioned to abut the arcuate surface so as to fluidly block the ring flow bore; and the sprinkler head is configured to regulate a water flow rate from the water supply to approximately a third of an unregulated water flow rate from said water supply, and wherein the ball is configured to be urged against the arcuate surface under the unregulated water flow rate, yet be disposed below the sealing ring under the water flow rate regulated by the sprinkler head.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention;

FIG. 2 is an exploded view of an exemplary embodiment of the present invention;

FIG. 3 is a section view of an exemplary embodiment of the present invention, taken along line 3-3 of FIG. 1, with some components removed for clarity;

FIG. 4 is a section view of an exemplary embodiment of the present invention, taken along line 4-4 of FIG. 3;

FIG. 5 is a detailed section view of an exemplary embodiment of the present invention in an open condition, illustrating a ball 26 suspended below a sealing ring 12 by a regulated, predetermined flow rate; and

FIG. 6 is a detailed section view of an exemplary embodiment of the present invention in a closed condition, illustrating the ball 26 held in the sealing ring 12 by pressure from a unregulated flow rate.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a ball check valve for individual sprinkler heads of an irrigation system, wherein the respective ball check valve stops the water flow of unregulated flow resulting from a malfunctioning sprinkler head/nozzle incapable of sufficiently decreasing, regulating the water flow. The ball check valve provides a sealing ring fluidly communicating an upper and lower flow bores within a valve tube, wherein the sealing ring provides a downward-facing arcuate surface dimensioned to snugly receive a ball bearing in a closed position. The ball check valve is adapted so that only unregulated flow urges the closed position, wherein regulated flow from a properly functioning sprinkler head enables an open position with the ball bearing below the sealing ring in the lower bore.

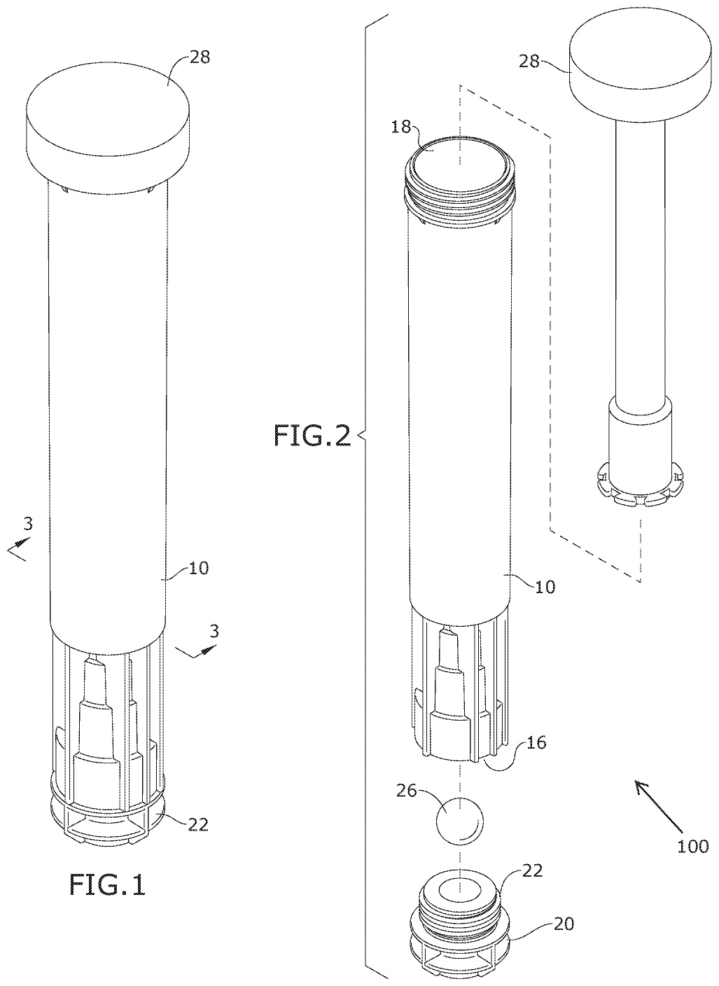

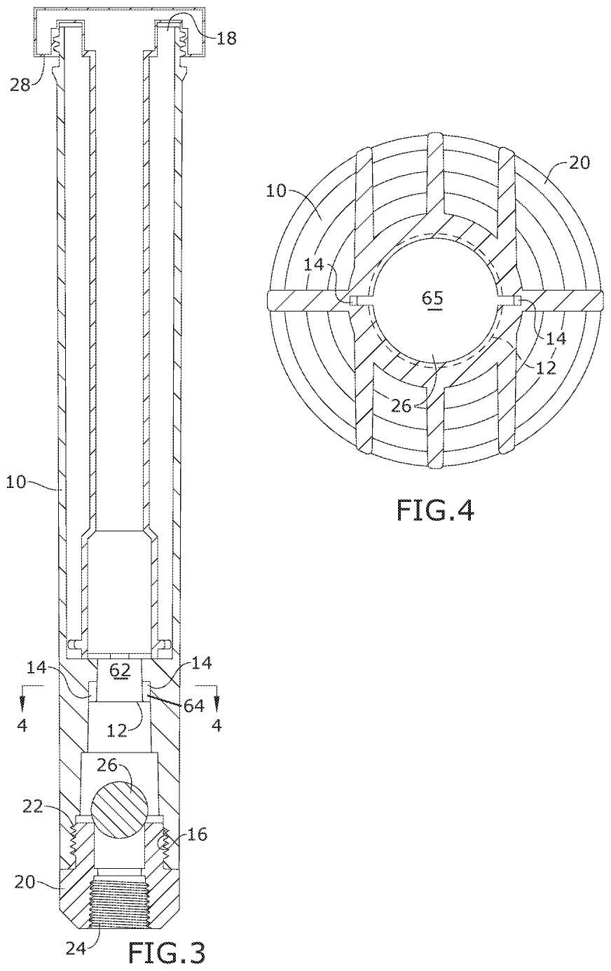

Referring to FIGS. 1 through 6, the present invention may include a ball check valve 100 for incorporation in individual sprinkler heads of an irrigation system. The ball check valve 100 may include a valve tube 10 defining a lower flow bore 50 and a fluidly connected upper flow bore 52. Disposed between the first and second flow bores 50 and 52 is a sealing flange 60. The sealing flange 60 defines a sealing flow bore that is smaller than the lower and upper flow bores 50 and 52. A sealing ring 12 is dimensioned to engage the sealing flange 60. The sealing ring 12 may have a base portion 62 and a flange portion 64, both which define a shared ring flow bore 65. The base portion 62 is dimensioned and adapted to snugly slide into the sealing flow bore, while the wider flange portion 64 interfaces with the sealing flange 60. The flange portion 64 may have a flange diameter that is approximately thirty percent greater than a base diameter of the base portion 62. When the sealing ring 12 engages the sealing flange 60 the flange portion 64 protrudes into the lower flow bore 50. Therein, the flange portion 64 provides a downward-facing arcuate surface 66 dimensioned and adapted to snugly engage a ball 26 also embodied by the present invention, which closes off the ring flow bore 65, stopping an upward flow of water 32. The flange portion 64 may provide one or more bypass grooves 14. In certain embodiments, the one or more bypass grooves 14 are two diametrically oppose grooves, which in certain embodiments may be ⅛″ long, 1/32″ wide, ⅛″ deep. The valve tube 10 extends from a top open end 18 to a bottom open end. It should be understood by those skilled in the art that the use of directional terms such as top, upper, upward and bottom, lower, downward, and the like are used in relation to the illustrative embodiments as they are depicted in the figures, the upward/top direction being toward the top of the corresponding figures and a downward/bottom direction being toward the bottom of the corresponding figures.

The bottom open provides inner threading 16 for removably coupling to a bottom coupling 20 having exterior threading 22 dimensioned and adapted to engage the inner threading 16 so that the bottom coupling 20 closes off the bottom end except for a bottom coupling bore providing inner coupling threading 24 for operatively associating with a water source 30 for supplying water 32 to the ball check valve 100. The top end 18 is dimensioned and adapted to removably and operatively associate with various types of sprinkler heads 28. In certain embodiments, the sprinkler head 28 may be connected in a fixed manner.

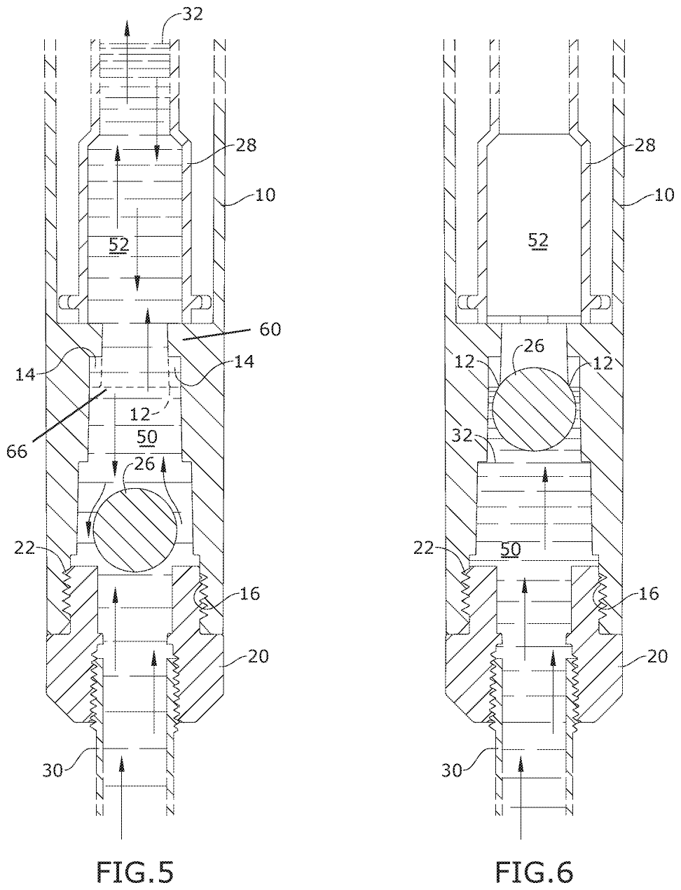

A method of using the present invention may include the following. The ball check valve 100 disclosed above may be provided. The inner coupling threading 24 may be fluidly coupled to the water source 30 so that the valve tube 10 is in a vertical orientation relative to ground level, as illustrated in FIGS. 5 and 6, with the resulting water flow is directed from the lower flow bore 50 to upper flow bore 52. The sprinkler head 28 may be adapted to regulate said water flow to a predetermined rate. The predetermined rate is approximately one-third of the unregulated rate of water flow when the sprinkler is removed, broken or otherwise incapable of regulating the water flow. The ball 26 is between the bottom end and the sealing ring 12, wherein the ball 26 is adapted as a function of mass, size and buoyancy, among other things, to be buoyed between the bottom end and the sealing ring 12 during the predetermined rate of water flow regulated by the sprinkler head 28, enabling the open position illustrated in FIG. 5, yet be urged against the arcuate surface 66 when the unregulated water flow is present, effectuating the closed position illustrated in FIG. 6. The ball 26 may be made of steel.

In the normal operating mode when the water is first providing by the water source 30, the ball 26 may be forced up into the arcuate surface 66, effectuating the closed position, shutting off most of the water supply to the top end 18. The one or more bypass grooves 14 still allowing enough water 32 to get by to pressurize the upper flow bore 52, enabling the water flow to equalize and in turn the ball 26 falls back down to the lower flow bore 50—self enabling the open position. This also allows the user to initially connect the sprinkler head 28 during this period, if necessary.

As a result of the foregoing, if the sprinkler head/nozzle 28 or pipe above ground breaks off or becomes damaged the resulting increase in the water flow rate forces the ball 26 up into the arcuate surface 66 restricting water flow in the closed position. With no change in the pressure up stream, in the upper flow bore 52, of the ball 26 the water will remain restricted until the problem is resolved.

In most cases the unregulated water flow in residential homes is 15 gallons per minute (GPM). The water source 30 conduits may provide a diameter ½″ to ¾″ for coupling (in certain embodiments, by way of a bushing) to the valve tube 10, which may be one-inch in diameter. With a spray nozzle 28 attached, the predetermined flow rate is reduced to between two and three GPM depending on the size nozzle 28 being used. In other embodiments, the unregulated 15 GPM may be reduced from between twelve to four GPM. This will save the homeowner the loss of between 360 and 390 gallons of water when the system is operating for a normal thirty-minute run time per zone.

For retrofitting purposes, a user would only have to remove the internal workings of their old pop up spray body, unscrew the old spray body and then screw on the new spray body valve tube 10, replacing the internal workings of the pop-up spray head.

It should be understood, of course, that the foregoing relates to exemplary embodiments of the invention and that modifications may be made without departing from the spirit and scope of the invention as set forth in the following claims.

What is claimed is:

1. A ball check valve for an individual sprinkler head of an irrigation system, comprising:
a valve tube having fluidly connected upper and lower flow bores;
a sealing ring separating said upper and lower flow bores;
the sealing ring providing a ring flow bore fluidly coupling the upper and lower flow bores;
a downward-facing arcuate surface provided along a lower portion of the sealing ring, wherein the lower portion protrudes in the lower flow bore; and
a ball disposed in the lower flow bore, wherein the ball is dimensioned to abut the arcuate surface so as to fluidly block the ring flow bore.

2. The ball check valve of claim 1, further comprising a sealing flange disposed between the upper and the lower flow bores;
the sealing flange defining a sealing flow bore;
the sealing ring having a base portion and a flange portion that both define the ring flow bore; and
the base portion dimensioned to slide into and abut the sealing flow bore,
wherein the flange portion provides the arcuate surface.

3. The ball check valve of claim 1, wherein the valve tube extends between a bottom end and a top end, wherein the bottom end is dimensioned to operatively associate with a water supply, and wherein the top end is dimensioned to operatively associate with a sprinkler head.

4. The ball check valve of claim 3, wherein the sprinkler head is adapted to regulate a water flow rate from the water supply to approximately a third of an unregulated water flow rate from said water supply.

5. The ball check valve of claim 4, wherein the ball is dimensioned and adapted to be urged against the arcuate surface under an unregulated water flow rate, yet be disposed below the sealing ring under the water flow rate regulated by the sprinkler head.

6. A ball check valve for an individual sprinkler head of an irrigation system, comprising:
a valve tube having fluidly connected upper and lower flow bores;
the valve tube extends between a bottom end and a top end, wherein the bottom end is dimensioned to operatively associate with a water supply, and wherein the top end is dimensioned to operatively associate with a sprinkler head;
a sealing flange disposed between the upper and the lower flow bores;
the sealing flange defining a sealing flow bore;
a sealing ring having a base portion and a flange portion that both define a shared ring flow bore; and
the base portion dimensioned to slide into and abut the sealing flow bore,
wherein the flange portion provides a downward-facing arcuate surface provided along a lower portion of the sealing ring, wherein the lower portion protrudes in the lower flow bore;
a ball disposed in the lower flow bore, wherein the ball is dimensioned to abut the arcuate surface so as to fluidly block the ring flow bore; and
the sprinkler head is configured to regulate a water flow rate from the water supply to approximately a third of an unregulated water flow rate from said water supply, and
wherein the ball is configured to be urged against the arcuate surface under the unregulated water flow rate, yet be disposed below the sealing ring under the water flow rate regulated by the sprinkler head.

7. An irrigation system for shutting off one or more discrete sprinkler heads when each sprinkler head has a malfunctioning nozzle, comprising:
installing the ball check valve of claim 6 in a plurality of discreet sprinkler heads fluidly coupled to the shared water supply.
